(19) United States
(12) Patent Application Publication
(10) Pub. No.: US 2022/0297314 A1
(43) Pub. Date: Sep. 22, 2022

(54) Mechanical Robot Tool Changer

(71) Applicants: Mark Eugene Ganninger, Leander, TX (US); Dillon Eugene Ganninger, Georgetown, TX (US)

(72) Inventors: Mark Eugene Ganninger, Leander, TX (US); Dillon Eugene Ganninger, Georgetown, TX (US)

(21) Appl. No.: 17/695,706

(22) Filed: Mar. 15, 2022

Related U.S. Application Data
(60) Provisional application No. 63/161,925, filed on Mar. 16, 2021.

(51) Int. Cl. B25J 15/04; B25J 9/02; B25J 9/10; B25J 19/06

(52) U.S. Cl. CPC B25J 15/0425; B25J 9/023; B25J 9/101; B25J 15/0491; B25J 19/06; B23B 2260/02

(57) ABSTRACT

The apparatus and method described herein allows for the automated replacement of end effectors on a robot without requiring external power source such as electricity or compressed air. The programmed robot motion provides the mechanism for tool changing. This simplified approach provides a simpler, less expensive solution to systems currently provided. The robot motion provides the mechanism and all the power needed to enable the tool changing.

### FIELD

This disclosure relates to robot tool systems in automated environments which sometimes require multiple effectors to complete tasks and those effectors require electricity or compressed air.

### CROSS-REFERENCE TO RELATED APPLICATIONS

This application claims the benefit of U.S. Provisional application 63/161,925 filed Mar. 16, 2021. The aforementioned patent application is hereby incorporated by reference in its entirety into the present application to the extent consistent with the present application.

### BACKGROUND

Robot systems in an automated environment will sometimes require multiple end effectors to allow completion of the robot tasks. Existing automated end effector tool changers typically require a power source such as compressed air or electricity. The Mechanical Robot Tool Changer described herein utilizes only the robots motion and mechanical locking to change end effectors. Prior art tool changers utilizing air would be similar to U.S. Pat. No. 10,759,061.

There is a need for alternate approaches that do not require electric power or compressed air.

### SUMMARY OF THE DISCLOSURE

This need is met by a method for use in a robotic tool system using multiple slave tools that automatically replaces end effectors on a robot arm by utilizing only the robot's motion and mechanical locking to complete all of the tasks without the normal need of external power sources such as electricity or compressed air, the method including at least the steps of: providing a master tool changer bolted on the end of the robot arm comprising a top robot interface plate designed to match the particular robot being used; providing a lock pin located below the top robot interface used to lock the master tool changer to any of the multiple slave tools; providing one or more slave tools, each of which has a top interface plate designed to accept the lock pin located below the top robot interface of the upper master tool changer; providing an interior spring within the slave tool; providing multiple tool holders bolted in precise locations surrounding the robotic tool which house the robotic tool systems slave tools; wherein the robot using its own power aligns the pins with the entry slots of the slave tool and compresses the interior spring in the slave tool and moves down and then rotates 20 degrees or more and enters a slot that captures the pin with the power of the spring, locking the slave tool to the master tool.

In addition the method for use in a robotic tool system using multiple slave tools that automatically replaces end effectors on a robot arm by utilizing only the robot's motion and mechanical locking to complete all of the tasks without the normal need of external power sources such as electricity or compressed air of wherein the master tool changer is unlocked and removed from the slave tool by the robot using its own power compresses the interior spring in the slave tool and moves down and then rotates 20 degrees or more and releases the pin from the slot that captured the pin with the power of the spring, unlocking the slave tool from the master tool changer.

And in addition disclosed is a robotic tool system using multiple slave tools with end effectors that automatically replaces end effectors on a robot arm by utilizing only the robot's motion and mechanical locking to complete all of the tasks without the normal need of external power sources such as electricity or compressed air including at least: a master tool changer bolted on the end of the robot arm comprising a top robot interface plate designed to match the particular robot being used; a lock pin located below the top robot interface used to lock the master tool changer to any of the multiple slave tools; one or more slave tools, each of which has a top interface plate designed to accept the lock pin located below the top robot interface of the upper master tool changer; an interior spring within the slave tool; an interior slot within the slave tool that accepts the lock pin of the master tool changer, which locks the master tool changer to the slave tool using the power of the spring; and multiple tool holders bolted in precise locations surrounding the robotic tool which house the robotic tool systems slave tools.

### BRIEF DESCRIPTION OF THE DRAWINGS

FIG. 1 is a schematic drawing of the Master Tool Changer permanently attached to the robot.

FIG. 2 is a schematic drawing of the Tool Changer Assembly.

FIG. 3 is a schematic drawing of the Master Tool Changer.

FIG. 4 is a schematic drawing of a Slave Tool

FIG. 5 is a schematic drawing of the tool holder into which Slave Tools are loaded.

FIG. 6 is a schematic drawing showing that multiple tool holders can be distributed around the robot cell, carrying multiple tools.

FIG. 7 is a schematic drawing illustrating the mechanical orientation of Slave Tools in the tool holder.

FIG. 8 is a schematic drawing illustrating employing the robot to move the Tool Holder with the Slave Tool and orient the Master Tool Changer to the tool.

FIG. 9 is a schematic drawing illustrating employing the robot to move the Master Tool Holder into the Slave Tool.

FIG. 10 is a schematic exploded view illustrating the components of the Master Tool.

FIG. 11 is a schematic exploded view illustrating the components of the Slave Tool.

### DETAILED DESCRIPTION

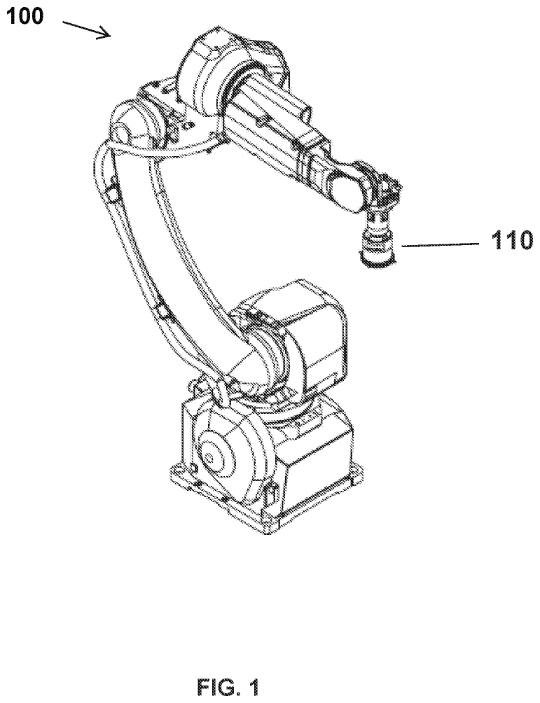

FIG. 1, shown generally as 100, illustrates an example industrial robot. It is one kind of industrial robot but this description can apply to many industrial robots be used in diverse applications. Shown at the very end of the robot arm is a tool changer assembly 110 which are common in robotic operations. Later Figures will illustrate a tool changer assembly in more detail.

In the industry there are many companies that sell tool changers. They have a Master tool, and they have Slaves tools. This importantly enables users to have several Slave tools readily available for different tasks.

These tool changer assemblies require power sources, either electrical or compressed air in order to carry out the tool changing function as the programmed robot is carrying out its programmed tasks.

The robot is typically mounted on a table with guarding around it and several tool holders mounted are on the table around the robot. For example, if you were grinding something and that required both a grinder and a polisher you would put those two Slave Tools in their holders and when the program required grinding the robot would go to the holder with the grinder slave tool, pick it up, install it and begin grinding. After the grinding is completed the robot uses the Master Tool Changer to remove the grinding slave tool and replace it in its holder on the table and then pick up the polisher slave tool and us it for the polishing portion of the work. During operation the holders would have one empty holder. The tool change assembly, master tool, slave tools and slave tool holders are illustrated in more detail in the following Figures.

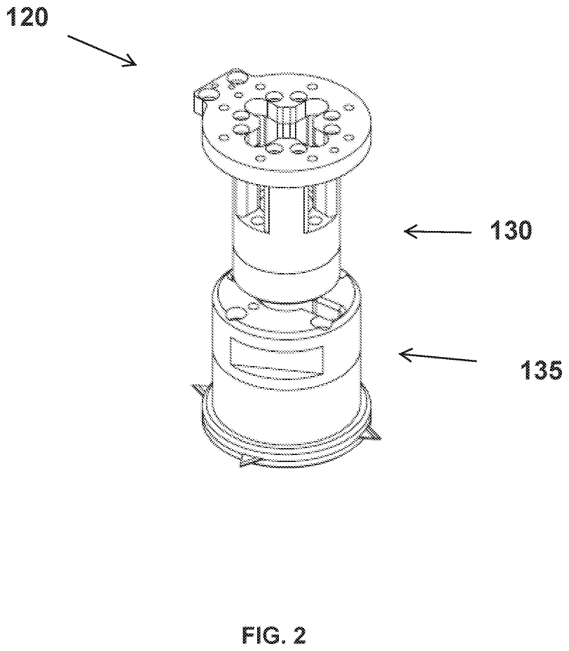

FIG. 2, shown generally as 120, is a tool changer assembly comprising an upper master tool changer 130 and a lower slave tool 135. This corresponds to the assembly 110 shown at the end of the robot arm in FIG. 1

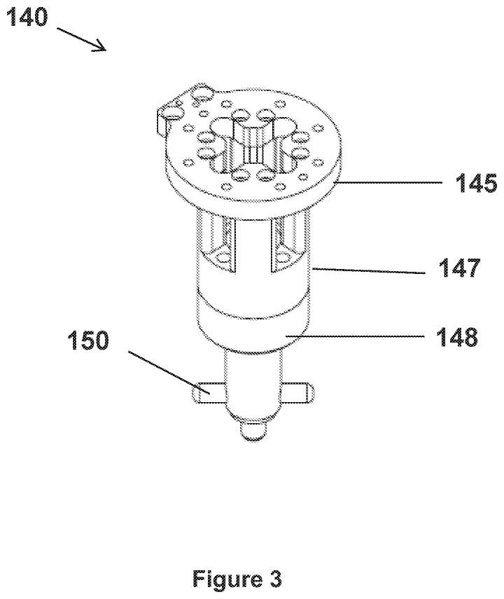

FIG. 3, shown generally as 140, is an example upper master tool changer as described herein that is bolted on the end of the robot arm and is used to insert and remove the various slave tools needed for a particular application. The top robot interface plate 145 is designed to match up with the particular robot. The lock pin 150 is used to lock the master tool changer to the various slave tools (to be shown). Its use will be described in a later Figure.

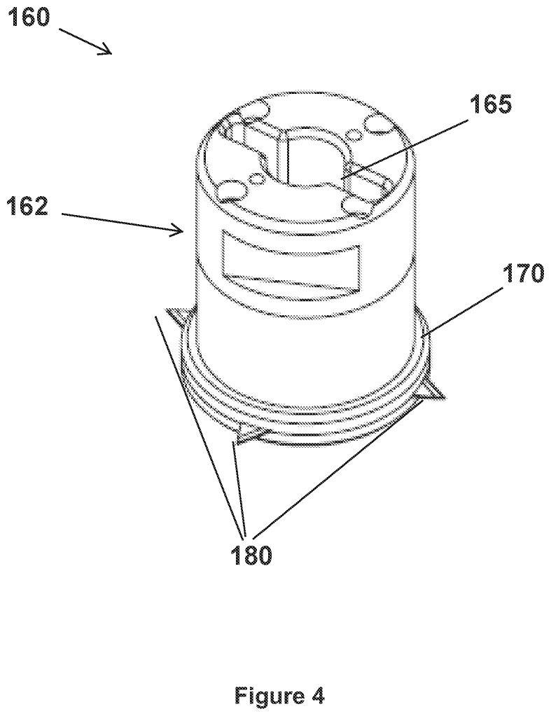

FIG. 4, shown generally as 160, is an example of a slave tool. More precisely, the top section 162 might be considered the slave tool and the distinct section at the bottom 170 is usually called an end effector. Note that the top interface plate of the slave tool has an opening 165 specifically designed to accept the lock pin (150 in FIG. 3) of the upper master tool changer

An end effector 170, sometimes known an End-of-Arm Tooling (EOAT), is the device at the end of a robotic arm designed to interact with the environment and do the work. In this particular example the end effector is represented by these embedded cutter blades 180 for a robotic application of cutting boxes open as the slave tool is rotated. But the end effector could be many other things. Different effectors can be bolted on for different applications. All types of end effectors can be used, grippers, paint guns, grinders, polishers, etc.

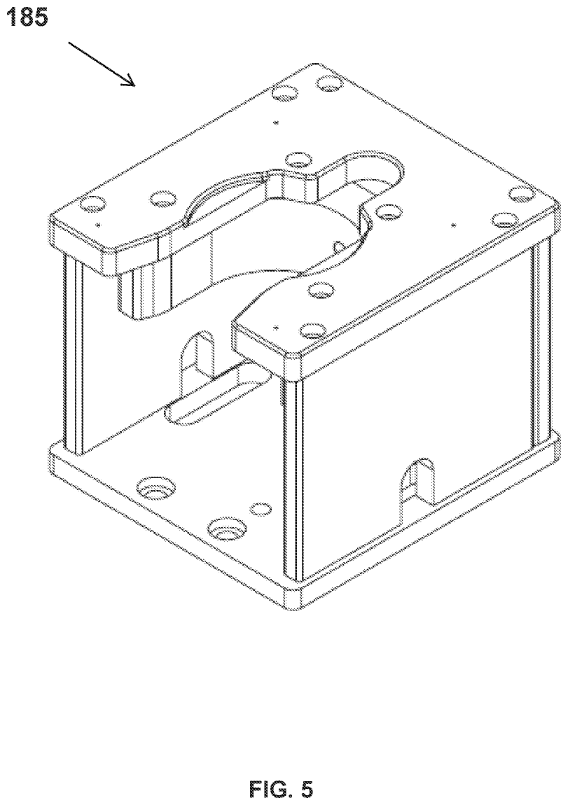

When not in use the slave tools must be stored. FIG. 5, shown generally as 185 is a tool holder. As previously discussed these are usually bolted in precise locations surrounding the robot and the slave tools are stored in them when not in use.

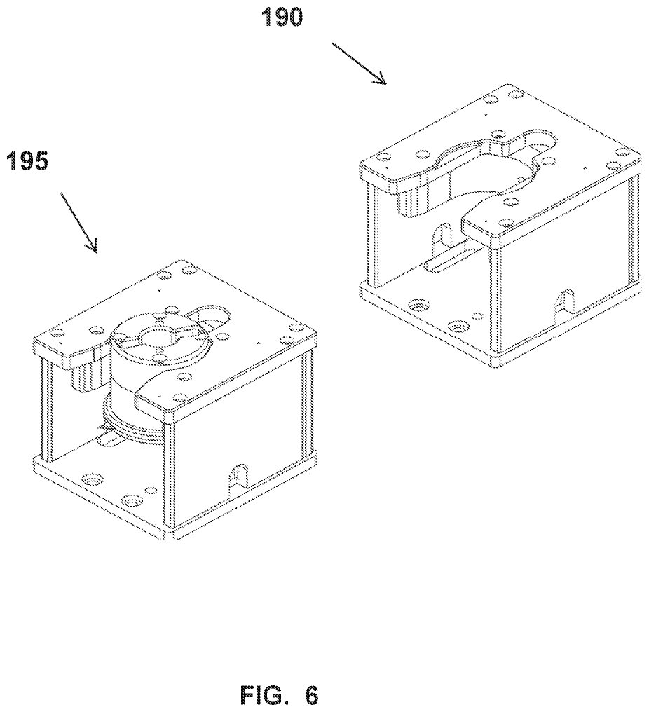

FIG. 6 illustrates this, showing two tool holders, one 195 holding the slave tool of FIG. 4, and the second one 190 being the holder that stores the slave tool currently in use by the robot. There is no limitation to the number of tool holders, it is simply how many that you need. But in a many applications it is about 2-4 tool holders.

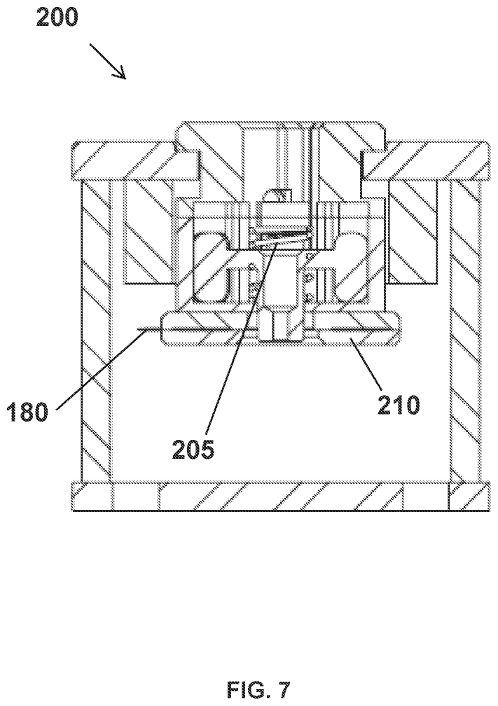

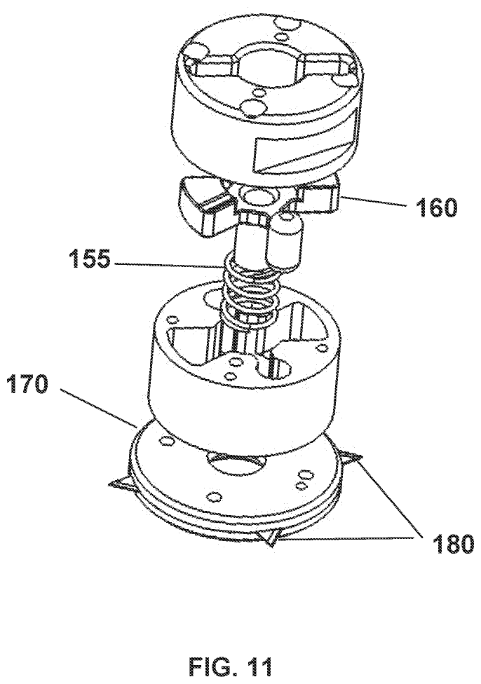

FIG. 7, shown generally as 200 is a side cross sectional view of a slave tool mounted in a tool holder. Everything above numeral 210 is the slave tool mounted in the tool holder. Numeral 210 represents the end effector 170 shown as an example in FIG. 4. One of the blades 180 appearing in FIG. 4 can be seen here in FIG. 7. Also shown is an internal spring 205, whose purpose will be explained in FIG. 11.

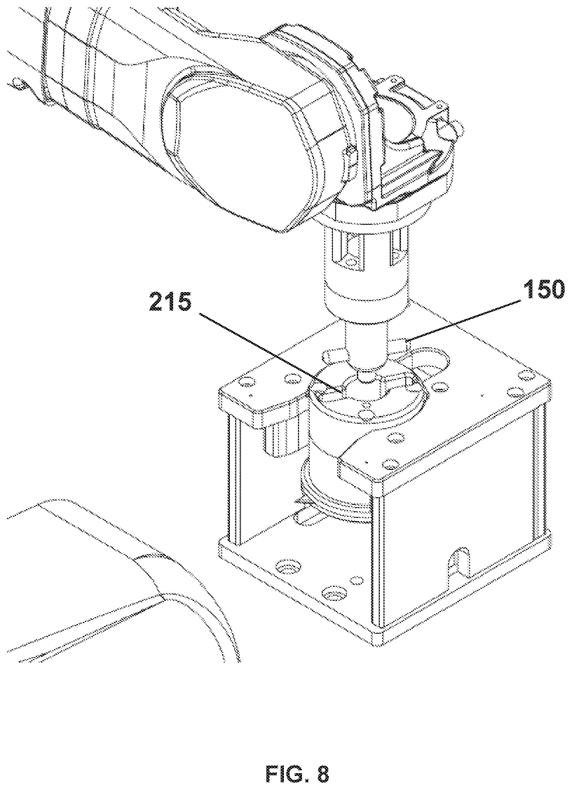

FIG. 8 illustrates how the tool changing works in use. The robot using its own power only aligns the pin 150 with the entry slots of the slave tool 215 and compresses an interior spring (shown in FIG. 7, and to be shown in FIG. 11) in the slave tool as it moves down and then rotates (about 20 degrees or more) and enters a slot (to be shown in FIG. 11) that captures the pin with the power of the spring. After this step the slave tool is then firmly locked to the Master tool.

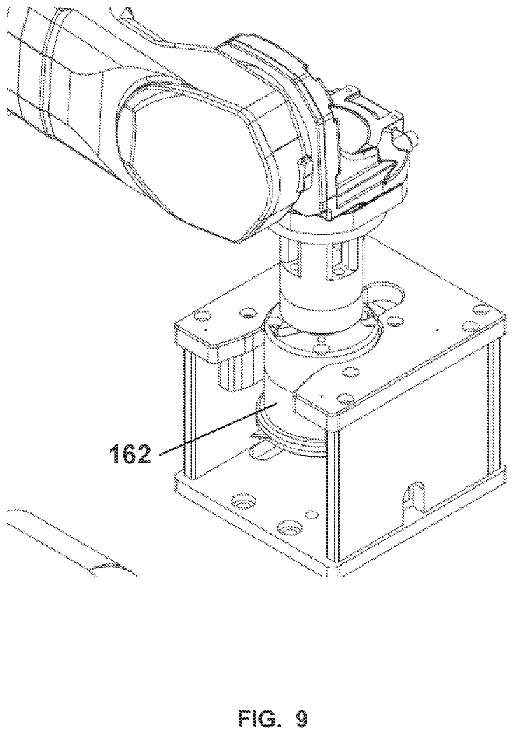

FIG. 9 illustrates the end result with the master tool changer 140 locked to the slave tool 162 in its holder. The robot is programmed to do all of this and then lift the slave tool 162 (with its particular end effector) and apply it to its application. All of this is done without any need for electrical or compressed air equipment driving the tool changing process.

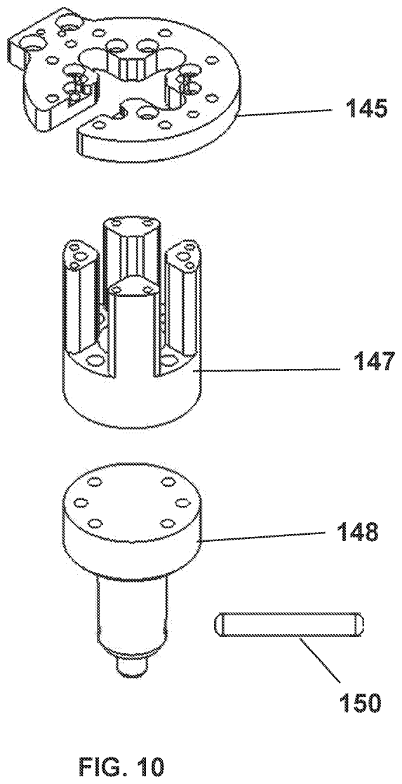

FIGS. 10 and 11 are exploded views of the master tool (10) and the slave tool (11) to clarify the internals.

FIG. 10 the exploded view for clarity of the upper master tool shown earlier in FIG. 3. Numeral 145, was described earlier as the robot interface plate custom designed for the particular robot. The lower master tool 148 with accompanying pin 150 is the lower portion. Numeral 147 is an interface piece between the robot interface plate and the master tool and is a custom piece designed for each application.

FIG. 11 is the exploded view for clarity of the slave tool of FIG. 4 which also clarifies the method. An interior strong spring 155 is compressed downward as the master tool pin (of FIGS. 4 and 10) is pushed down by the programmed movement of the robot and after compression the master tool is rotated, causing the pin to enter a slot near numeral 160 and when the downward force is relieved the spring captures the pin and locks the master tool to the slave tool. Numeral 170 is again the end effector including ((in this example) cutter blades 180 for cutting boxes.

This disclosure has been described with reference to specific details of particular embodiments. It is not intended that such detailed be regarded as limitations upon the scope of the invention except insofar as and to the extent that they are included in any accompanying claims.

1. A method for use in a robotic tool system using multiple slave tools that automatically replaces end effectors on a robot arm by utilizing only the robot's motion and mechanical locking to complete all of the tasks without the normal need of external power sources such as electricity or compressed air, the method comprising the steps of:
a. providing a master tool changer bolted on the end of the robot arm comprising a top robot interface plate designed to match the particular robot being used;
b. providing a lock pin located below the top robot interface used to lock the master tool changer to any of the multiple slave tools;
c. providing one or more slave tools, each of which has a top interface plate designed to accept the lock pin located below the top robot interface of the upper master tool changer;
d. providing an interior spring within the slave tool;
e. providing multiple tool holders bolted in precise locations surrounding the robotic tool which house the robotic tool systems slave tools; and
f. wherein the robot using its own power aligns the pins with the entry slots of the slave tool and compresses the interior spring in the slave tool and moves down and then rotates 20 degrees or more and enters a slot that captures the pin with the power of the spring, locking the slave tool to the master tool.

2. The method for use in a robotic tool system using multiple slave tools that automatically replaces end effectors on a robot arm by utilizing only the robot's motion and mechanical locking to complete all of the tasks without the normal need of external power sources such as electricity or compressed air of claim 2 wherein the master tool changer is unlocked and removed from the slave tool by the robot using its own power compresses an interior spring in the slave tool and moves down and then rotates 20 degrees or more and releases the pin from the slot that captured the pin with the power of the spring, unlocking locking the slave tool from the master tool changer.

3. A robotic tool system using multiple slave tools with end effectors that automatically replaces end effectors on a robot arm by utilizing only the robot's motion and mechanical locking to complete all of the tasks without the normal need of external power sources such as electricity or compressed air comprising:
a. a master tool changer bolted on the end of the robot arm comprising a top robot interface plate designed to match the particular robot being used;
b. a lock pin located below the top robot interface used to lock the master tool changer to any of the multiple slave tools;
c. one or more slave tools, each of which has a top interface plate designed to accept the lock pin located below the top robot interface of the upper master tool changer;
d. an interior spring within the slave tool;
e. an interior slot within the slave tool that accepts the lock pin of the master tool changer, which locks the master tool changer to the slave tool using the power of the spring; and
f. multiple tool holders bolted in precise locations surrounding the robotic tool which house the robotic tool systems slave tools.
